(19) United States
(12) Patent Application Publication
(10) Pub. No.: US 2006/0133310 A1
(43) Pub. Date: Jun. 22, 2006

(54) Information server in a communication system

(75) Inventor: Jaakko Rajaniemi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/071,368

(22) Filed: Mar. 4, 2005

(30) Foreign Application Priority Data
Dec. 22, 2004 (FI) 20041655

(51) Int. Cl. H04Q 7/00

(52) U.S. Cl. 370/328

(57) ABSTRACT

A method provides handling a request to access a mobile information server. The method comprises receiving a request to access a mobile information server. The method further comprises determining whether informing of the request is required. The method further comprises informing of the request when the step of determining shows that the informing is required. Furthermore, an information server and a computer program are configured to execute the method.

### FIELD OF THE INVENTION

The invention relates to communication systems, and more specifically to information servers. In particular, the invention relates to mobile information servers implemented in mobile communication devices. Furthermore, the invention relates to handling a request to access a mobile information server.

### BACKGROUND OF THE INVENTION

A communication system can be seen as a facility that enables communication sessions between two or more entities such as one or more communication devices and/or other nodes associated with the communication system. A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS). Further examples of wireless communication systems may comprise wireless local area network (WLAN), wireless packet switched data networks, such as a wireless Internet Protocol (IP) network and so on.

A mobile communication network may logically be divided into a radio access network (RAN) and a core network (CN). The core network entities typically include various control entities and gateways for enabling communication via a number of radio access networks and also for interfacing a single communication system with one or more communication systems, such as with other wireless systems and/or fixed line communication systems. Examples of radio access networks may comprise the UMTS terrestrial radio access network (UTRAN) and the GSM/EDGE radio access network (GERAN).

Subscribers, such as the users or end-users, to a communication system may be offered and provided numerous services, such as calls, data communication or multimedia services or simply an access to a network, such as the Internet. Servers may be used in provision of the services and may be operated by an operator of a network or by an external service provider. For example, a mobile communication device may allow a user thereof to browse the Internet. For example, the wireless application protocol (WAP) provides mobile communication devices wireless services over the Internet from fixed information servers, such as Internet servers and Web servers.

Recently, it has been proposed that an information server, such as a Web server, might be implemented in a mobile communication device or mobile terminal. A server implemented in a mobile terminal, i.e. a mobile server, may enable various new uses, such as immediate sharing of pictures taken by the user of the terminal and so on. In this context, a mobile server may be defined in other words as non-fixed or non-stationary server.

A U.S. patent application Ser. No. 10/611647, filed on 1 Jul. 2003, in the name of Qu, describes a system, apparatus and method for providing a mobile information server providing information resources as a HTTP server.

### SUMMARY OF THE INVENTION

In accordance with an aspect of the invention, there is provided a method for handling a request to access a mobile information server. The method comprises receiving a request to access a mobile information server. The method further comprises determining whether informing of the request is required. The method further comprises informing of the request when the step of determining shows that the informing is required.

In accordance with a further aspect of the invention, there is provided a mobile information server for a communication system. The information server is configured to receive a request to access a mobile information server. The information server is further configured to determine whether informing of the request is required. The information server is further configured to inform of the request when the step of determining shows that the informing is required.

In an embodiment, the informing may be given by means of a sound alert, flashing lights alert or vibrating alert. In an embodiment, the informing may comprise giving an alert window or an alert window including information about the requesting client. In an embodiment, the informing may comprise giving an alert window asking an authorization of the request.

In accordance with a further aspect of the invention, there is provided a computer program comprising program code means for performing any of the steps according to embodiments of the invention when the program is run on a computing means.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 shows a further example of an arrangement in which the embodiments of the invention may be implemented;

FIG. 3 shows a signaling chart of an embodiment of the invention; and

FIG. 4 shows a flow chart illustrating an embodiment of the invention.

### DETAILED DESCRIPTION OF PREFERRED EMBODIMENTS

Embodiments of the invention are now illustrated in association with a mobile network. A mobile communication network, such as a GPRS or an UMTS network, is typically arranged to serve a plurality of mobile communication devices usually via a wireless interface between a mobile communication device and at least one transceiver network element of the communication network, such as a base transceiver station (BTS) or a Node B. A transceiver network element typically serves a geographical area or a plurality of geographical areas. Such a geographical area may also be referred to as a cell. One or more transceiver network elements may be controlled by a controller network element, such as a base station controller (BSC) or a radio network controller (RNC). The mobile communication system may logically be divided between a radio access network (RAN) and a core network (CN).

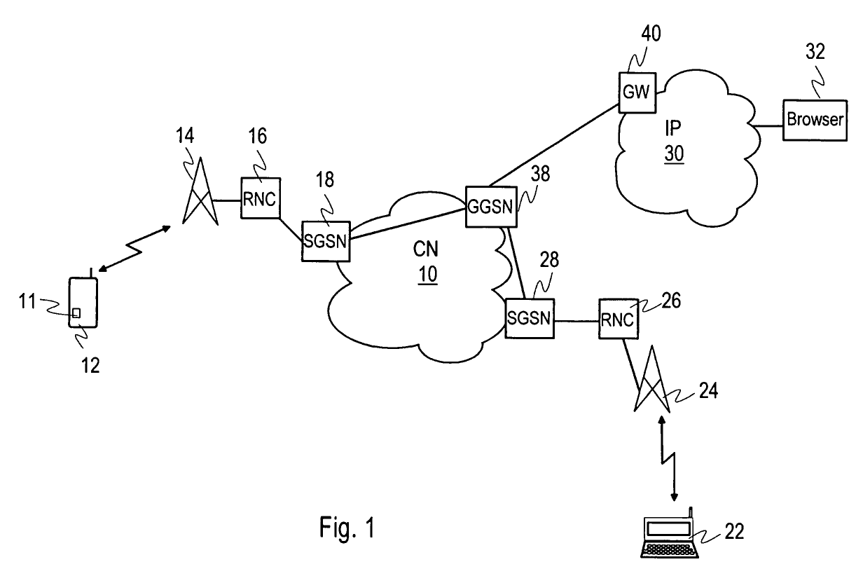

Reference is made to FIG. 1 showing an example of a network architecture in which the embodiments of the invention may be implemented. In FIG. 1, a mobile communication device 12 is arranged to access a communication core network 10 via a radio access network comprising a transceiver network element 14 and a controller network element 16. The communication device 12 is arranged to transmit signals to and receive signals from the transceiver network element 14 via a wireless interface between the communication device and the transceiver network element. Correspondingly, the transceiver network element is able to transmit signals to and receive signals from the communication device via the wireless interface.

Furthermore, a communication device 22 is arranged to access the core network via a radio access network comprising a transceiver network element 24 and a controller network element 26.

It shall be appreciated that, although only two communication devices are shown in FIG. 1 for clarity, a number of communication devices may be in simultaneous communication with one or more transceiver network elements of a communication system. Furthermore, although for clarity FIG. 1 shows only two exemplifying transceiver network elements and two exemplifying controller network elements, a typical communication network system usually includes a number of radio access networks. A controller may be assigned for each transceiver network element or a controller can control a plurality of transceiver network elements, for example in the radio access network level. It shall be appreciated that the name, location and number of the network controllers may vary depending on the system.

The core network (CN) entities typically include various switching and other control entities and gateways for enabling the communication via a number of radio access networks and also for interfacing a single communication system with one or more communication systems, such as with other cellular systems and/or fixed line communication systems. The radio access network controller is typically connected to an appropriate core network entity or entities such as, but not limited to, a serving general packet radio service support node (SGSN) 18, 28. The radio access network controller 16, 26 is in communication with the SGSN 18, 28 via an appropriate interface, for example on an Iu or Gb interface.

The SGSN is responsible for delivery of data packets to and from the communication devices within a service area. The SGSN may perform packet routing and transfer, mobility management, logical link management, authentication, charging functions, and so on. The SGSN may store location information of a communication device, such as the current cell and a visiting location register (VLR) associated with the communication device. Furthermore, the SGSN may store information on user profiles, such as the International Mobile Subscriber Identity Number (IMSI) of all the communication devices registered with the SGSN.

Furthermore, a gateway GPRS support node (GGSN) 38 may act as a gateway between the core network 10 and other communication systems, such as an IP network 30. A gateway 40, such as a HTTP proxy or a WAP proxy, is also shown connected to the GGSN 38. The gateway may provide means for handling mobility, provide a firewall and addressing and so on. The operation of the exemplifying gateway 40 will become clear from the following description. The gateway 40 may be placed in an appropriate location in the communication system. The gateway 40 may be in the exemplifying IP network 30 as shown in FIG. 1. In an alternative, the gateway 40 may locate in the core network. Other alternative architectures may be possible as well.

An end-user may access a communication network by means of any appropriate communication device, also called terminal. Examples may comprise user equipment (UE), a mobile station (MS), a cellular phone, a personal digital assistant (PDA) and a personal computer (PC). Further examples may comprise any other equipment operable according to a suitable network or transport protocol, such as a Session Initiation Protocol (SIP), a Real-Time Transmission Protocol (RTP), a File Delivery over Unidirectional Transport (FLUTE), a wireless applications protocol (WAP) or a hypertext transfer protocol (HTTP).

A communication device may be provided with an antenna or other such transceiver and receiver means for wirelessly receiving and transmitting signals from and to a transceiver network element of a wireless communication system. A communication device may also be provided with a display and a speaker. The operation of a communication device may be controlled by means of a suitable user interface comprising control means, such as a keypad, voice commands, touch sensitive screen or pad, or combinations thereof, or the like. The user interface may display a user a menu, a list or the like and allow the user to select an option from the menu. The user may indicate the selection by using the control means. The user interface may detect user activity and communicate the selection to a communicating logic of the communication device. A communication device is typically provided with a processor and memory means as well as software and applications operating the device and enabling operation with other entities. Software, which is able to request services from other entities in a communication system, may be called a client.

A communication system may support the session initiation protocol (SIP) as developed by the Internet engineering task force (IETF). The SIP is an application layer control protocol for creating, modifying and terminating sessions with one or more participants, i.e. end-points. A user connected to a SIP base communication system may communicate with various entities of the communication system based on standardized SIP messages. Communication devices or users who run certain applications on the communication devices are registered with the SIP backbone so that an invitation to a particular session can be correctly delivered to these end points. Uniform Resource Identifiers (URIs) are used to identify different types of actors in a SIP-controlled network. Typically a URI points to a registered user identity of an individual user. A URI may identify also services or other types of resources.

In embodiments of the invention, an information server 11, such as a Web server or Web services provider functionality, is implemented in the mobile communication device 12. The mobile communication device 12 hosting the information server 11 shall be called herein also a web server mobile terminal 12.

For example, for implementing the information server in the mobile communication device, the principles disclosed in the U.S. patent application Ser. No. 10/611647 (referred to as U.S. Ser. No. 10/611647 herein) may be used. An exemplifying implementation based on the U.S. Ser. No. 10/611647 is summarized in the following with reference to FIG. 1. However, it shall be understood by a skilled person that other ways of implementing a web server in a mobile terminal may be used in embodiments of the invention. It shall be appreciated that embodiments of the invention are not limited to any particular communication environment, but may occur in any appropriate communication system.

The web server mobile terminal 12 may provide information resources and act as an HTTP server. Other terminals operating as HTTP clients may comprise web services clients (WSC), such as a client in the mobile communication device 22, or Internet browsers 32 operating within the IP network 30. The HTTP clients may access information provided in the server 11 through the use of HTTP. A client requesting to access the information provided in the server 11 may also be called a requesting client relating to a requesting terminal herein. The web server mobile terminal 12 may, for example, be used for publishing an information resource, such as a home page in wireless markup language (WML), hypertext markup language (HTML) or extensible hypertext markup language (XHTML), or image or video content, or the like. A user of the web server mobile terminal 12 may further define access controls to the information resource. The Web services provider may respond with HTTP including a simple object access protocol (SOAP) or, more generally, extensible markup language (XML) body.

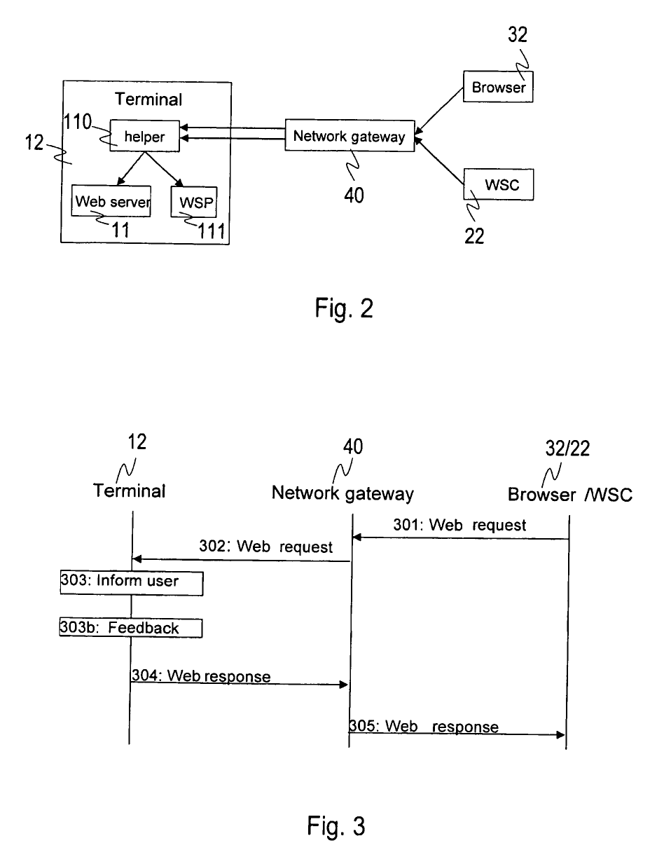

FIG. 2 shows more in detail an embodiment for implementing the web server (HTTP server) 11 and/or a web services provider (WSP) process 111 in the web server mobile terminal 12. An HTTP request may be generated by a client, such as the WSC in the mobile communication device 22, and be delivered to the HTTP server 11 in the web server mobile terminal 12. The request may pass though the gateway 40 towards a processor means, such as a helper 110, in the web server mobile terminal 12. The helper 110 may forward the request to the web server 11 or to a web service provider (WSP) 111. In an embodiment, the helper 110 may be omitted and the request may pass directly to the to the HTTP server 11 or the WSP 111. One or more web services providers may be associated with the web server 11. An example of a service provided by an exemplifying WSP may comprise, but is not limited to providing location information. Web services clients may use services in the terminal anywhere from the Internet, e.g. for fetching location information directly from the terminal, whenever the terminal has an Internet connectivity.

The HTTP request may comprise a request line defining a method to be applied to the resource, the URI of the resource and the protocol version used. The HTTP request may comprise further components, such as a general header having general applicability to request and response messages, a request header allowing a client to pass additional information about the request, an entity header defining meta-information about an entity body and a message body carrying the entity body associated with the request, and/or other further components.

An exemplary HTTP request line using a “GET” tag indicating the method to be applied to the resource according to the prior art may be as follows:

GET http://www.w3.org/pub/WWW/TheProject.html HTTP/1.1

The exemplary request line includes the familiar URI pathname, http://www.w3.org/pub/WWW/”. The file “TheProject.html” is to be retrieved as a result of the “GET” request from the URI. Mobile terminals, however, do not have an IP address or a URI associated with them. Therefore, HTTP GET request-line as indicated above is not compatible with, for example, mobile terminal 12, when content is desired to be retrieved from mobile terminal 12.

In embodiments of the invention, the proposed URI pathname used in an HTTP GET request from the mobile communication device 22, for example, may take a form of “http://www.domain-name/identifier” or “http:identifier.domain-name”. The “identifier” portion of the URI pathname reflects the identity of the web server mobile terminal 12 and the “domain-name” portion of the URI pathname reflects the domain name of a gateway 40 in the network. The identifier can be user's name, nick name, MSISDN or any other identifier which identifies the communication device of the user.

After receiving the HTTP request, the gateway 40 may proxy the request to mobile terminal 12, for example via GPRS network as tunneled IP data or other communication means, e.g. SIP, MMS, WAP Push or a short message service (SMS) (not shown) or another appropriate path. In an embodiment, the gateway 40 may additionally send the MSISDN of mobile terminal 22 to mobile terminal 12 for authentication and authorization of mobile terminal 22.

Data access from the web server mobile terminal 12 may be performed in a number of different ways, for example, by tunneling the data between the mobile terminal 12 and the gateway 40 using IP techniques. In other words, normal HTTP traffic may be tunneled between the mobile terminal 12 and the gateway 40. This is possible because the mobile terminal 12 needs to register or inform about itself to the gateway 40 and set-up said tunneling in order to be available to external devices. In an embodiment, also the HTTP request may go directly to the server, if the gateway is not needed in the system.

It has now been found that it might be desirable to provide means for informing a user of the communication device implementing the web server about incoming requests to access the web server. Furthermore, it might be desirable to enable the user to allow or disallow a requested transaction to be completed. For example, the user may be enabled to select whether to provide the location of the user in response to a particular request.

In an embodiment, the web server mobile terminal 12 includes a functionality providing information to a user of the terminal 12 about incoming requests to access the web server 11. An incoming web service request may be received from a requesting client, such as a browser 32 or a WSC 22. When the request is received in the terminal 12, the terminal may inform the user of the incoming service request or not based on how the terminal 12 is configured. Informing the user may comprise sound, flashing lights or vibrating alert. Furthermore, informing the user may comprise an alert window, possibly including information about the requesting client, such as from where and who is contacting the web server 11 and/or what is requested. Furthermore, informing the user may comprise an alert window asking the user to authorize the request. For example, the incoming request may query location of the user and the user may select to allow (or authorize) or disallow (or refuse) responding to the request. Informing the user may comprise one or more of the previous actions and/or further appropriate actions.

In an embodiment, informing the user may occur only once when a new user makes a first request. For example, when a new user starts to browse the content of the terminal using an Internet browser, the user of the web server mobile terminal 12 may be informed only in the beginning. Information, such as an alert, relating to subsequent requests may be omitted.

Informing the user may be triggered in a number of ways. The user of the web server mobile terminal 12 may be allowed to configure triggers for an alert. Examples of triggers may comprise, but are not limited to, a particular user requesting an access to the web service provided by the terminal or an unknown user requesting an access to the service.

In an embodiment, if an alert window asking the user to authorize the request is configured to show up, a further configuration may configure subsequent request handling from the same user in some way. For example, the same user may be allowed to access the service without further informing or alerting to the user of the web server mobile terminal 12 hosting the service.

In an embodiment, the web server mobile terminal 12 may know who is contacting the server or the service based on information comprised in the request. In an embodiment, the requesting user may input a username and/or a password in the request, for example if the web server mobile terminal has been configured to ask for the username and/or the password. In another embodiment, the web server mobile terminal may ask for the username and/or the password from the requesting client when a service request is received.

FIG. 3 shows an exemplifying signaling flow according to an embodiment of the invention. In signal 301, a request to access the web server is transmitted from the requesting terminal, such as the browser 32 or the WSC 22, and received in the gateway 40. In signal 302, the request is forwarded from the gateway 40 towards the web server mobile terminal 12. The user is informed of the incoming web request, referred to as 303.

In a first embodiment, the informing does not change the response and the response is sent to the gateway 40 in signal 304. The response may comprise the requested information.

In a second embodiment, the terminal waits for a feedback 303b from the user. A response is formed based on the feedback 303b and sent to the gateway in signal 304. When the feedback of the user allows responding to the request, the response may be formed as in the first embodiment. When the feedback disallows responding to the request in a requested manner, the response may comprise respective information. For example, such respective information may be: “No response can be provided” or similar information to a user of the requesting client.

The gateway 40 forwards the response to the requesting client 22, 32 in signal 305.

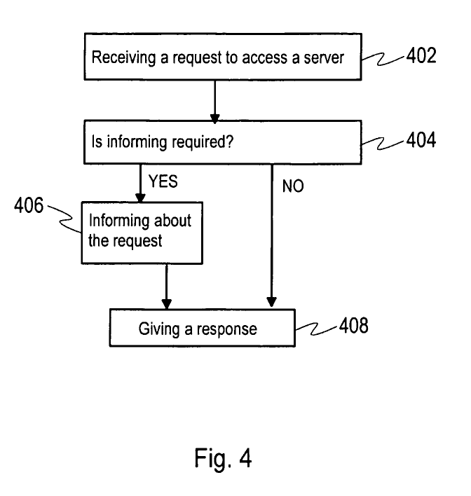

FIG. 4 shows a method 400 according to an embodiment of the invention. In step 402, a request to access a mobile information server is received in a terminal hosting the mobile information server. In step 404, it is determined whether informing of the request is required. For example, a processor in the terminal verifies if a configuration for requiring the informing exists. In step 406, a user of the terminal hosting the mobile information server is informed of the request when the step of determining shows that the informing is required. The user may be informed for example using the exemplifying alerts described above. A response is given in step 408. As was explained, the response may or may not depend on the feedback given by the user. When the step of determining shows that the informing is not required, a response may be given directly in step 408.

Embodiments of the invention may be performed, at least in part, by means of a computer program comprising program code means for performing any of the steps according to embodiments when the program is run on a computing means.

Although the invention has been described in the context of particular embodiments, various modifications are possible without departing from the scope and spirit of the invention as defined by the appended claims. In particular, even if a mobile telephone is mainly used as an exemplifying device providing the server, embodiments of the invention may be implemented in another appropriate communication device.

1. A method for handling a request to access a mobile information server, the method comprising:
receiving a request to access a mobile information server;
determining whether informing of the request is required; and
informing of the request when the step of determining shows that the informing is required.

2. A method according to claim 1, wherein the step of informing comprises giving at least one of a sound alert, a flashing lights alert and a vibrating alert.

3. A method according to claim 1, wherein the step of informing comprises giving at least one of a first alert window and an alert window including information about a requesting client.

4. A method according to claim 1, wherein the step of informing comprises giving an alert window asking an authorization of the request.

5. A method according to claim 4, further comprising receiving one of an authorization and a refusal in response to the step of informing.

6. A method according to claim 1, further comprising giving a response to the request.

7. A method according to claim 6, wherein the step of giving the response comprises informing that the request is disallowed when a user disallows the request.

8. A method according to claim 5, further comprising allowing an access of subsequent requests from an authorized requesting party without a further alert window.

9. A method according to claim 5, further comprising allowing an access of subsequent requests from an authorized requesting party without further step of informing.

10. A method according to claim 1, wherein the step of determining comprises verifying whether the request is received from a requesting party for a first time.

11. A method according to claim 10, wherein the step of informing comprises informing of the request when the step of verifying shows that the request is received from the requesting party for the first time.

12. A method according to claim 10, wherein the step of determining comprises determining that the informing is not required when the step of verifying shows that previous requests have been received from said requesting party.

13. A method according to claim 12, wherein said requesting party is a user of an Internet browser.

14. A method according to claim 1, wherein the step of determining comprises determining whether a trigger is configured for triggering the step of informing.

15. A method according to claim 14, wherein the step of determining comprises determining whether the trigger comprising at least one of a particular user requesting an access to a web service provided by a terminal and an unknown user requesting an access to a service is configured.

16. A method according to claim 1, wherein the step of receiving comprises receiving, in the request, information about a requesting party.

17. A method according to claim 1, wherein the step of receiving comprises receiving, in the request, at least one of a username and a password.

18. A method according to claim 1, further comprising asking for at least one of a username and a password from a requesting party in response to the step of receiving the request.

19. A computer program, embodied on a computer readable medium, said computer program controlling a computing system to perform the steps of:
receiving a request to access a mobile information server;
determining whether informing of the request is required; and
informing of the request when the step of determining shows that the informing is required.

20. A mobile information server for a communication system, the information server configured to:
receive a request to access a mobile information server;
determine whether informing of the request is required; and
inform of the request when the step of determining shows that the informing is required.

21. An information server for a communication system, the information server comprising:
receiving means for receiving a request to access a mobile information server;
determining means for determining whether informing of the request is required; and
informing means for informing of the request when the step of determining shows that the informing is required

22. An information server for a communication system, the information server comprising:
a receiver for receiving a request to access a mobile information server;
a processor for determining whether informing of the request is required; and
an interface for informing of the request when the step of determining shows that the informing is required.
